(19) United States
(12) Patent Application Publication
(10) Pub. No.: US 2009/0080392 A1
(43) Pub. Date: Mar. 26, 2009

(54) Communication terminal device and communication transmission method

(76) Inventors: Cheng-Ta Parng, Taichung City (TW); Li-Chi Chiu, Yuanlin Township (TW); Johnson Liu, Sijhih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/073,582

(22) Filed: Mar. 7, 2008

(30) Foreign Application Priority Data
Sep. 21, 2007 (TW) 96135276

(51) Int. Cl. H04Q 7/24

(52) U.S. Cl. 370/338

(57) ABSTRACT

A communication terminal device is provided. The communication device includes a control unit, a WLAN module, a WMAN module and a VoIP module. The control unit provides a drive module for driving the WLAN module, the WMAN module and the VoIP module, and provides a real-time kernel module for achieving quality performance of the communication terminal device.

### BACKGROUND OF THE INVENTION

1. Field of the Invention

The present invention is related to a communication terminal device, and more particularly to a communication terminal device with wireless transmission capability and a method thereof.

2. Description of Related Art

Recently, characteristics of wireless communication products and technologies change continuously, and different kinds of broadband wireless access technologies are developed. Among these, WiFi and WiMAX are most common. WiFi (Wireless Fidelity) is a wireless communication standard conforming to, for example, IEEE 802.11. WiFi is a short range wireless communication technology, and the theoretical transmission speed of the newest WiFi MiMO (Multiple Input, Multiple Output) is up to 540 MB/s, with a transmission range of up to 200 m. WiMAX, (Worldwide Interoperability for Microwave Access) is a burgeoning wireless communication technology. The standard of this technology is called IEEE 802.16x and its transmission speed is up to 70 MB/s, and the transmission range is up to 50 km.

WiFi is specially designed for WLAN (Wireless Local Area Network) and WiMAX is designed for WMAN (Wireless Metropolitan Area Network), so that, in a populous area, WiFi is applied indoor for realizing low-cost and safe broadband access, and WiMAX is utilized for outdoor application. Therefore, for customer premises equipment (CPE), WiFi and WiMAX are two different kinds of communication standards and for both there is a requirement.

VoIP (Voice over Internet Protocol) is another new and developing technology in the field of telephone communication which utilizes the Internet to achieve bi-directional voice transmission, so that the user does no longer need to talk through the traditional PSTN (Public Switched Telephone Network), but alternatively can talk through Internet. Furthermore, VoIP also can allow the user to access Internet.

Consequently, at present WiFi, WiMAX and VoIP are all necessary communication standards, and the normal case is that each one is implemented by a separate product. Thus, the user can only make use of these standards through different communication products at different situations.

### SUMMARY OF THE INVENTION

The object of the present invention is to provide a communication terminal device and a communication transmission method which can integrate the functions of WLAM, WMAN and VoIP into one single hardware platform, so as to provide the user the interaction thereamong.

For achieving the object described above, the present invention provides a communication terminal device including a control unit, a WMAN (Wireless Metropolitan Area Network) module, a WLAN (Wireless Local Area Network) module, and a VoIP (Voice over Internet Protocol) module, wherein the control unit is respectively coupled to the WMAN module, the WLAN module and the VoIP module, and through a real-time kernel module the control unit can coordinate and distribute work loadings among the WMAN module, the WLAN module and the VoIP module. Thus, the functions of the WMAN module, the WLAN module and the VoIP module can be accessed sequentially or simultaneously, ensuring high operation efficiency when using the communication terminal device.

In another aspect of the present invention, a communication transmission method is provided. The method includes the steps of providing a control unit respectively coupled to a WMAN (Wireless Metropolitan Area Network) module, a WLAN (Wireless Local Area Network) module and a VoIP (Voice over Internet Protocol) module, and providing the control unit with a real-time kernel module, such that through the real-time kernel module, the control unit coordinates and distributes work loadings among the WMAN module, the WLAN module and the VoIP module.

### BRIEF DESCRIPTION OF THE DRAWINGS

The foregoing aspects and many of the attendant advantages of this application will be more readily appreciated as the same becomes better understood by reference to the following detailed description, when taken in conjunction with the accompanying drawings, wherein:

FIG. 1 is a block diagram showing a communication terminal device in a preferred embodiment according to the present invention;

FIG. 2 is a block diagram showing the function of a control unit;

FIG. 3 is a flow chart showing a preferred embodiment according to the present invention; and

FIG. 4 is a schematic view showing the architecture of a communication transmission system according to the present invention.

### DETAILED DESCRIPTION OF PREFERRED EMBODIMENTS

In the present invention, one-single hardware is utilized to be the process and control core of communication and operation among multiple communication modules with different transmission standards. Furthermore, the hardware also provides a controlling procedure to control individual or all communication modules, so that resource requirements between all communication modules can be allotted effectively, thereby ensuring the quality of operation efficiency.

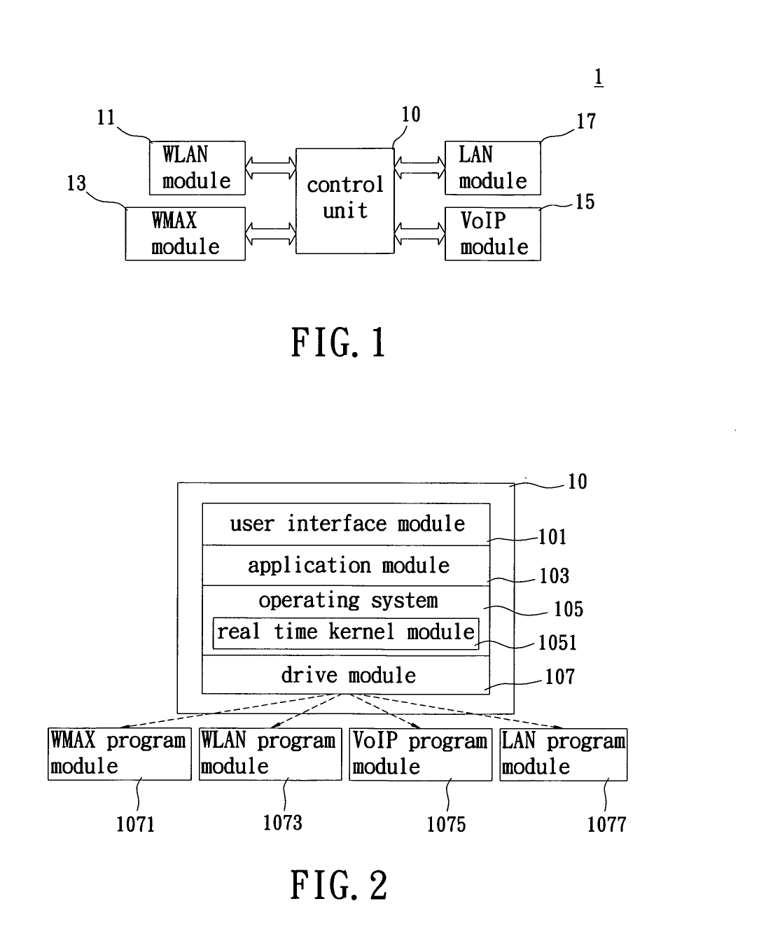

Please refer to FIG. 1, which is a block diagram showing the communication terminal device 1 of the present invention. In this embodiment, the communication terminal 1 includes a control unit 10, a WLAN module 1, a WMAN module 13, a VoIP (Voice over Internet Protocol) 15 and a LAN module 17, wherein the control unit 10 is a programmable microprocessor and is used to control the communications and transmissions of the WLAN module 1, the WMAN module 13, the VoIP module 15 and the LAN module 17.

The control unit 10 is coupled to the WLAN module 11, the WMAN module 13, the VoIP module 15 and the LAN module 17 through a proper connection interface, such that the WLAN module 1, the WMAN module 13, the VoIP module 15 and the LAN module 17 can have a mutual data transmission through the control unit 10, wherein the VoIP module 15 is coupled to the control unit 10 through a HPI (Hardware Platform Interface) and the LAN 17 is coupled to the control unit 10 through a GMI (Gigabit Media Independent Interface).

The communication transmission methods provided in this embodiment mainly are wired transmission and wireless transmission, wherein the WLAN module 11 and the WMAN module 13 are responsible for wireless transmission, and the VoIP module 15 and the LAN module 17 are utilized to provide the function of wired transmission. The WLAN module 11 is compatible with a WiFi (Wireless Fidelity) module of 802.11 wireless communication transmission standard, the WMAN module 13 belongs to a WiMAX (World Interoperability for Microwave Access) module which is compatible with 802.16 wireless communication transmission standards, and the LAN module 17 is an Ethernet module.

Please further refer to FIG. 2. The control procedure provide by the control unit 10 is executed by a user interface module 101, an application module 103, an operating system 105, and a drive module 107. The operating system 15 is the main control mechanism in the control procedure, wherein the operating system 15 can execute the function of the communication terminal device 1 through the application module 103, and the user interface module 101 can be used to acquire the commands inputted by the user. Here, the user interface module can be graphical user interface or a command line interface, and the operating system 105 can control the hardware connected to the communication terminal device 1 through the drive module 107.

For smoothly driving the WLAN module 11, the WMAN module 13, the VoIP module 15 and the LAN module 17, the control unit 10 is provided with the drive module 107, in which includes a WMAN program module 1071 for driving the WMAN module 13, a WLAN program module 1073 for driving the WLAN module 11, a VoIP program module 1075 for driving the VoIP module 15, and a LAN program module 1077 for driving the LAN module 17. Moreover, the operating system 105 also can support various lower protocols and interconnection port drivers, so as to transmit the communication messages among the WLAN module 11, the WMAN module 13, the VoIP module 15 and the LAN module 17.

For individually or simultaneously controlling the WLAN module 11, the WMAN module 13, the VoIP module 15 and the LAN module 17, the control unit 10 utilizes a real-time kernel module 1051 in the operating system 105 to process loading coordination and distribution, and further, the real time kernel module 1051 will also control the driver module 107 for solving the problem of resource competition or resource insufficiency among the WLAN module 11, the WMAN module 13, the VoIP module 15 and the LAN module 17.

Moreover, when operating, the operating system 105 also can establish a data transmission pathway among the WLAN module 11, the WMAN module 13, the VoIP module 15 and the LAN module 17 according to the operation requirement of the application module 103, so that, through various combinations, the communication terminal device 1 can become a gateway for transmitting network data, voice data or multimedia data.

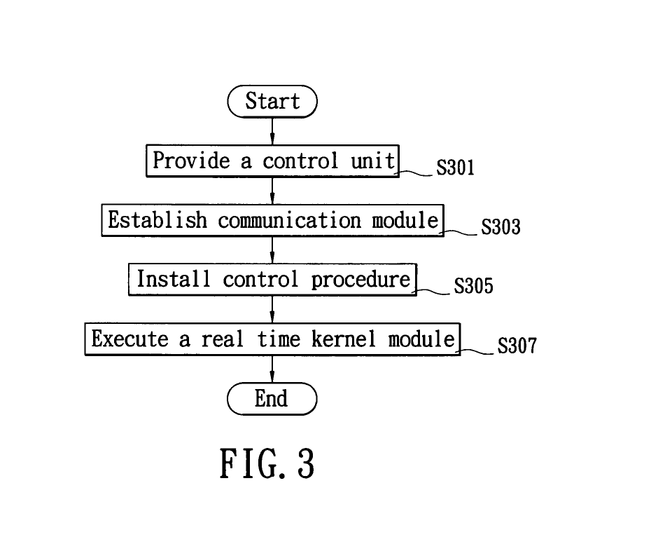

Please further refer to FIG. 3, which is a flow chart showing a preferred embodiment of the present invention. The steps are described as followed.

First, a control unit 10 is provided (Step S301) which can be a programmable microprocessor, and then a communication module used for external transmission is connected to the control unit 10 (Step 303). Here, this communication module is the WLAN module 11, the WMAN module 13, the VoIP module 15 and the LAN module 17. Continuously, the control procedure is installed into the control unit 10 (Step 305), so that the control unit 10 can drive the WLAN module 11, the WMAN module 13, the VoIP module 15 and the LAN module 17 through the operating system 105. Then, the real-time kernel module 1051 in the operating system 105 is executed (Step 307) for coordinating and distributing the working resource requirement among the WLAN module 11, the WMAN module 13, the VoIP module 15 and the LAN module 17, so that the control unit 10 can provide the function of gateway through the WLAN module 11, the WMAN module 13, the VoIP module 15 and the LAN module 17.

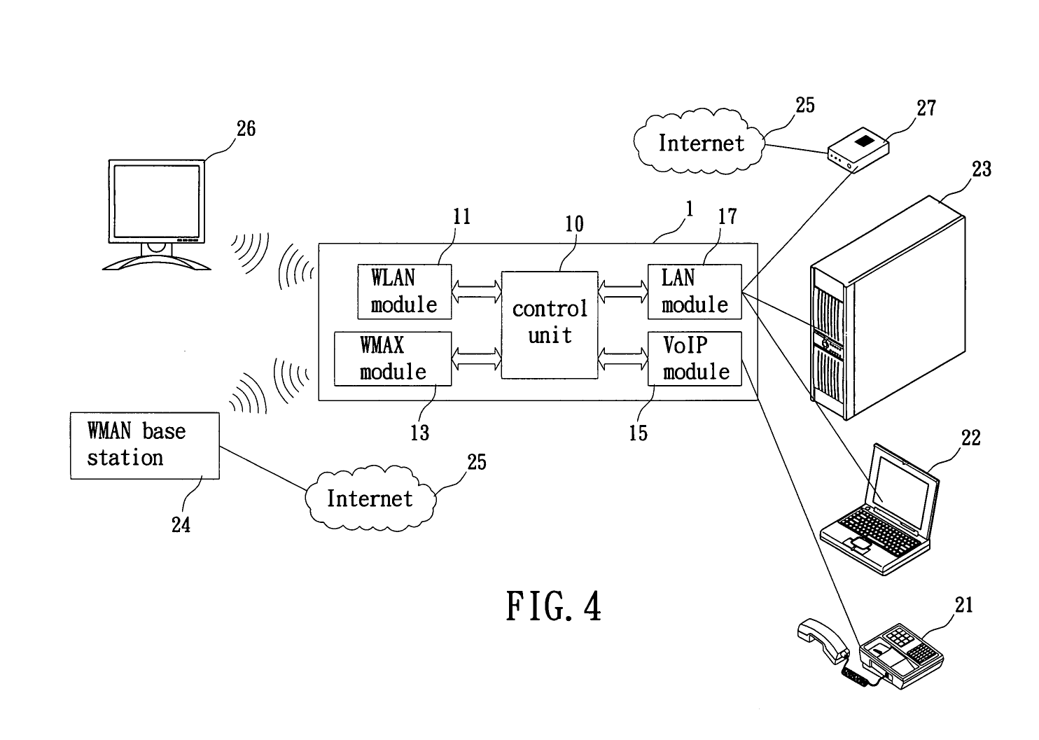

Please refer to FIG. 4, which is a schematic view showing the architecture of a communication transmission system according to the present invention. In the architecture disclosed in FIG. 4, the communication terminal device 1 has a wired or wireless connection with an external device for implementing the gateway function, wherein the VoIP module 15 can have a wired connection with a telephone 21, the LAN module 17 can be connected to a network server 23, a computer 22 or a modem 27 in wire, the WMAN module 13 can be wirelessly connected a WMAN base station 24, and the WLAN module 11 can be wirelessly connected to a multimedia electronic device 26, which supports the wireless communication transmission standard conforming to the WLAN module 11.

According to the architecture shown in FIG. 4, the communication terminal device 1 can be used to provide the function of VoIP gateway. Under this condition, the control unit 10 will establish the data transmission pathway between the VoIP module 15 and the WMAN module 13 or the LAN module 17, so that the communication terminal device 1 can be connected to Internet 25 through the WMAN base station 24 or the modem 27. Thereby the user can communicate with another VoIP user at the other end of Internet 25 through the telephone 21, effectively communicating voice data through telephone and Internet 25.

Furthermore, the communication terminal device 1 also can be used to provide the function of a network gateway or router. Under this condition, the control unit 10 can establish the data transmission pathway between the WLAN module 11 and the WMAN module 13 or the LAN module 17, so that the communication terminal device 1 can be connected to Internet 25 through the WMAN base station 24 or the modem 27, thereby the data from the multimedia electronic device 26, which is wirelessly connected to the WLAN module 11, can be transmitted on Internet 25.

Alternatively, the communication terminal device 1 also can be used to provide the function of WiMAX modem or hot spot of public WLAN service. Under this condition, the control unit 10 will establish the data transmission pathway between the WMAN module 13 and the LAN module 17 or the WLAN module 11, so that the communication terminal device 1 can be connected to Internet 25 through the WMAN base station 24 or the modem 27. Thereby the user can wirelessly access Internet through the multimedia electronic device 26, which is wirelessly connected to the WLAN module 11, or through the network server 23 or the computer 22 which is connected to the LAN module 17 in wire.

The communication terminal device 1 described above integrates modules of different communication protocols into one single control platform, and through the control signals from the control unit 10 and the real-time kernel module 105, the working resource requirements among hardware communication modules with different communication protocols can be coordinated and distributed, so that the communication terminal device 1 can be operated to have multiple functions of VoIP gateway, network gateway, router, WiMAX modem or hot spot of public WLAN service and still maintain the operation efficiency of each function at the same time.

Accordingly, the one single communication terminal device of the present invention can meet multiple operation requirements in different communication protocols which conventionally must be accomplished in multiple communication products. Thus, not only costs but also the necessary hardware volume can be reduced.

It is to be understood, however, that even though numerous characteristics and advantages of the present application have been set forth in the foregoing description, together with details of the structure and function of the application, the disclosure is illustrative only, and changes may be made in detail, especially in matters of shape, size, and arrangement of parts within the principles of the application to the full extent indicated by the broad general meaning of the terms in which the appended claims are expressed.

What is claimed is:

1. A communication terminal device, comprising:
a control unit, having a real-time kernel module;
a WMAN (Wireless Metropolitan Area Network) module, coupled to the control unit;
a WLAN (Wireless Local Area Network) module, coupled to the control unit; and
a VoIP (Voice over Internet Protocol) module, coupled to the control unit, wherein the control unit utilizes the real-time kernel module to coordinate and distribute work loadings among the WMAN module, the WLAN module and the VoIP module.

2. The communication terminal device as claimed in claim 1, wherein the control unit further comprises:
a drive module, for receiving a control signal from the real-time kernel module so as to drive the WMAN module, the WLAN module and the VoIP module.

3. The communication terminal device as claimed in claim 2, wherein the drive module comprises:
a WMAN program module, for driving the WMAN module;
a WLAN program module, for driving the WLAN module; and
a VoIP program module, for driving the VoIP module.

4. The communication terminal device as claimed in claim 2, further comprising:
a LAN (Local Area Network) module, coupled to the control unit for receiving a coordination control signal from the real-time kernel module.

5. The communication terminal device as claimed in claim 4, wherein the drive module further comprises:
a LAN program module, for driving the LAN module.

6. The communication terminal device as claimed in claim 5, wherein the LAN program module is an Ethernet module.

7. The communication terminal device as claimed in claim 1, wherein the WMAN module is a WiMAX (Worldwide Interoperability for Microwave Access) module.

8. The communication terminal device as claimed in claim 1, wherein the WLAN module is a WiFi (Wireless Fidelity) module.

9. The communication terminal device as claimed in claim 1, wherein the control unit is a programmable microprocessor.

10. A communication transmission method, comprising the steps of:
providing a control unit respectively coupled to a WMAN (Wireless Metropolitan Area Network) module, a WLAN (Wireless Local Area Network) module and a VoIP (Voice over Internet Protocol) module; and
providing the control unit with a real-time kernel module, such that through the real-time kernel module, the control unit coordinates and distributes work loadings among the WMAN module, the WLAN module and the VoIP module.

11. The method as claimed in claim 10, wherein the WMAN module is a WiMAX (Worldwide Interoperability for Microwave Access) module.

12. The method as claimed in claim 10, wherein the WLAN module is a WiFi (Wireless Fidelity) module.

13. The method as claimed in claim 10, further comprising the steps of:
providing a drive module to the real-time kernel module in the control unit for driving the WMAN module, the WLAN module and the VoIP module through the drive module.

14. The method as claimed in claim 13, wherein the drive module comprises:
a WMAN program module, for driving the WMAN module;
a WLAN program module, for driving the WLAN module; and
a VoIP program module, for driving the VoIP module.

15. The method as claimed in claim 10, further comprising the steps of:
connecting a telephone to the VoIP module by wire;
establishing communication between the WMAN module and a WMAN base station, which is connected to the Internet; and
establishing a data transmission pathway between the VoIP module and the WMAN module through the control unit, thereby transmitting voice data from the telephone to the Internet.

16. The method as claimed in claim 10, further comprising the steps of:
establishing communication between the WMAN module and a multimedia electronic device, wherein the multimedia electronic device supports a wireless communication transmission standard of the WMAN module; and
establishing communication between the WMAN module and a WMAN base station, which is connected to the Internet; and
establishing a data transmission pathway between the WLAN module and the WMAN module through the control unit.

17. The method as claimed in claim 10, further comprising the steps of:
providing a LAN program module coupled to the control unit for receiving a coordination control signal from the real-time kernel module;
connecting the LAN module to the Internet;
connecting a telephone to the VoIP module by wire; and
establishing a data transmission pathway between the LAN module and the VoIP module through the control unit.

18. The method as claimed in claim 10, further comprising the steps of:
providing a LAN program module coupled to the control unit for receiving a coordination control signal from the real-time kernel module;
connecting the LAN module to the Internet;
establishing communication between the WLAN module and a multimedia electronic device, wherein the multimedia electronic device supports a wireless communication transmission standard of the WLAN module; and
establishing a data transmission pathway between the LAN module and the WLAN module through the control unit.

19. The method as claimed in claim 10, further comprising the steps of:
providing a LAN program module coupled to the control unit for receiving a coordination control signal from the real-time kernel module;
connecting the LAN module to a network server;
establishing communication between the WMAN module and a WMAN base station, which is connected to the Internet; and
establishing a data transmission pathway between the LAN module and the WMAN module through the control unit.

20. The method as claimed in claim 10, further comprising the steps of:
providing a LAN program module coupled to the control unit for receiving a coordination control signal from the real-time kernel module;
connecting the LAN module to a computer;
establishing communication between the WMAN module and a WMAN base station, which is connected to the Internet; and
establishing a data transmission pathway between the LAN module and the WMAN module through the control unit.
